(19) United States
(12) Patent Application Publication
(10) Pub. No.: US 2026/0329741 A1
(43) Pub. Date: Oct. 22, 2026

(54) GAME PLAY DATA COLLECTION FOR AGENT SUPPORT

(71) Applicant: SONY INTERACTIVE ENTERTINMENT INC., Tokyo (JP)

(72) Inventors: Steve Agoston, Manhattan Beach, CA (US); Akshay Vadiraj Rao, Aliso Viejo, CA (US)

(21) Appl. No.: 19/185,083

(22) Filed: Apr. 21, 2025

(51) Int. Cl. G06F 11/3698; A63F 13/77

(52) U.S. Cl. CPC G06F 11/3698; A63F 13/77

(57) ABSTRACT

Techniques for described for video game information collection. An example method can include processing a message comprising a video game application identifier and first instructions to collect image information, audio information, and controller information generated during a cloud-based session of a video game application. The method can further include determining the cloud-based session of the video game application based on the video game application identifier. The method can further include collecting the image information, the audio information, and the controller information during the cloud-based session based on determining the cloud-based session. The method can further include synchronizing the controller information with the image information and the controller information with the audio information to generate synchronized video game information. The method can further include storing the synchronized video game information based on the video game application identifier.

### BACKGROUND

Video game debugging can be a process of identifying, analyzing, and resolving errors or glitches in a video game code to ensure that the video game functions as intended. Debugging can include examining game play behavior, code performance, and player interactions to pinpoint issues and implement fixes for an enjoyable gamer experience.

### BRIEF SUMMARY

The embodiments described herein describe techniques for collecting video game information during game play and without interrupting the game play experience for a player. The video game information can include image information (e.g., image frames), audio information (e.g., audio files), and controller information (e.g., controller inputs, haptic information from a haptic enabled controller).

A cloud computing system can be configured to detect a cloud-based session of a video game application. The cloud computing system can further be configured to access the controller information received at a cloud-based gaming server and the audio and image information that is generated based on the controller information. The cloud computing system can access the information such that the information is also transmitted to the player's gaming console in real time, such that the player does not experience any diminishment in game play experience. The collected information can be used to for various purposes, such as debugging and game play enhancement.

The cloud computing system can further be configured to search contextual information in the video game application. The contextual information can include, for example, a setting, a mini-boss, a boss, an item loadout or other contextual information. By collecting video game application that includes contextual information, the computing system can collect a diverse data set that provides the information to be used for downstream processing, such as game debugging and game enhancement. In addition to collecting video game information based on contextual information, the cloud computing system can augment the collected information with metadata to indicate the contextual information included in each instance of video game information.

### BRIEF DESCRIPTION OF THE DRAWINGS

FIG. 1 is an illustration of an example computer system that presents a dashboard, according to one or more embodiments.

FIG. 2 is an illustration of an example system for game play data collection, according to one or more embodiments.

FIG. 3 is an illustration of an example system for game play data collection, according to one or more embodiments.

FIG. 4 is an illustration of an example system for game play data collection, according to one or more embodiments.

FIG. 5 is an illustration of an example system for game play data collection, according to one or more embodiments.

FIG. 6 is an illustration of an example system for game play data collection, according to one or more embodiments.

FIG. 7 is an example process for game play data collection, according to one or more embodiments.

FIG. 8 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

A video game application can be under continuous improvement through various software updates. Either in the original video game application, or through one or more software updates, errors can be introduced into the video game application's code. The process of video game debugging can involve various issues, For example, the complexity of video games, which can include millions of lines of code and intricate interactions between game mechanics, graphics, and player inputs. Another issue can be that reproducing bugs can be difficult, especially when they occur under specific or rare conditions, such as unique hardware configurations, network latency in multiplayer environments, or unusual player actions. The process of debugging can also be time-intensive for analyzing and testing multiple systems and subsystems to isolate the root cause of an issue. Furthermore, the introduction of new features or updates to a video game application can create new bugs, leading to an ongoing cycle of testing and troubleshooting. Finally, debugging cloud-based or online games introduces additional challenges, such as managing server-side issues, ensuring synchronization across distributed systems, and addressing real-time player reports.

The techniques described herein address the above-referenced challenges. A computing system can leverage synchronized image information, audio information, and controller information collected during a video game session to identify errors in the video game application's code. The image information can provide a visual record of how the game responds to a player's controller input, while the audio information collects any anomalies in sound effects or in-game audio that may indicate underlying issues. The controller information can provide a log of the player's interactions, allowing the computing system to trace specific inputs that may trigger unexpected or erroneous behavior in the game. By analyzing the synchronized data, the computing system can determine discrepancies between the expected and actual outcomes, such as visual glitches, delayed responses, or incorrect audio cues. The techniques described herein can enhance debugging efficiency and also ensure that errors are identified in the broader context of the game play experience, leading to more accurate fixes and a smoother user experience.

The techniques described herein can include receiving a message that includes a video game application identifier and initial instructions to collect image information, audio information, and controller information generated during a cloud-based session of a video game application. The video game application identifier can serve as a reference to identify the specific video game being played in the cloud-based environment. Once the identifier is analyzed, the computing system can determine that a cloud-based session of the video game application is occurring.

After identifying the session of the video game application, the computing system can collect the image information, audio information, and controller information generated during the cloud-based game play. The image information can represent the graphical output of the game, the audio information can represent the sound effects and in-game audio, and the controller information can indicate the player's real-time interactions with the game through various input devices. These data streams can be intercepted en route to a user device in real time to preserve the game play experience of the player engaged in the cloud-based session.

The computing system can further synchronize the controller information with both the video and audio information. This synchronization process can align the gamer's inputs with the corresponding visual and auditory feedback to create a representation of the game play session. The synchronized video game information can be stored based on the video game application identifier. This step ensures the collected data is organized and easily retrievable for future use.

This techniques herein provide several technical advantages over conventional systems. The video, audio, and controller input can be used to create an accurate recreation of the game play experience without interfering with a gamer's experience. The use of a video game application identifier can permit session tracking and data retrieval, reducing the risk of misattributing data to the wrong game or session. Additionally, collecting data in a cloud-based environment enables scalability and accessibility, as users can store and retrieve game play information without being constrained by local hardware limitations.

In the interest of clarity of explanation, the embodiments may be described in connection with a video game system including a video game console. However, the embodiments are not limited as such and similarly apply to any other type of a computer system. Generally, a computer system presents a dashboard in a GUI on a display. The dashboard presents UI elements, each corresponding to an application, service, or collection of information.

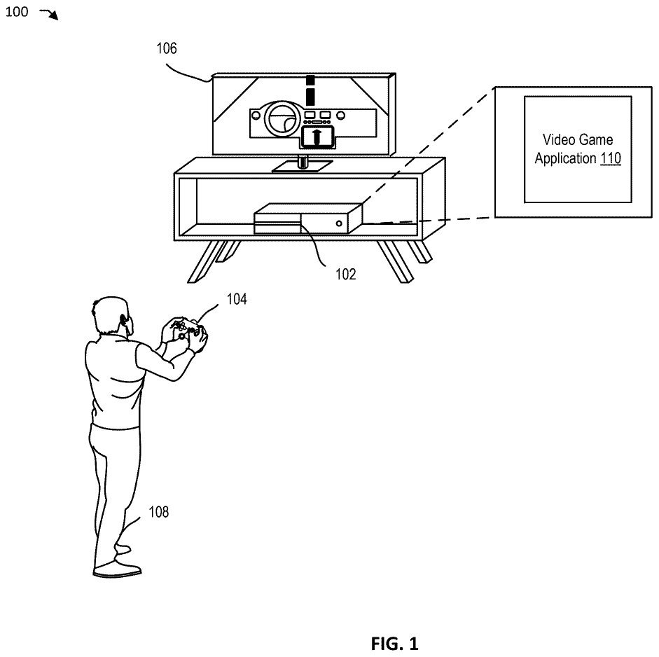

FIG. 1 is an illustration 100 of an example computer system that presents a dashboard, according to an embodiment of the present disclosure. As illustrated, the computer system includes a video game console 102, a video game controller 104, and a display 106. Although not shown, the computer system may also include a backend system, such as a set of cloud servers, that is communicatively coupled with the video game console 102. The video game console 102 is communicatively coupled with the video game controller 104 (e.g., over a wireless network) and with the display 106 (e.g., over a communications bus). A video game player 108 operates the video game controller 104 to interact with the video game console 102. These interactions may include playing a video game presented on the display 106, interacting with a menu presented on the display 106, and interacting with other applications of the video game console 102 (e.g., with media applications to stream media from an online content source or to play a media file from the local storage of the video game console 102).

The video game console 102 includes a processor and a memory (e.g., a non-transitory computer-readable storage medium) storing computer-readable instructions that can be executed by the processor and that, upon execution by the processor, cause the video game console 102 to perform operations related to various applications. In particular, the computer-readable instructions can correspond to program codes for the various applications of the video game console 102 including video game application 110, video game application 112, controller application 114, and audio application 116. A video game application, such as video game application 112, generally represents a computer application executable to present video game content, receive user interaction with the video game content, and accordingly update the video game content. The availability of a video game application, and/or other type of computer application to the video game player 108 via the video game console 102 can depend on a user identifier of the video game player 108 (e.g., upon a login to the video game console 102, the availability of the computer applications can depend on the user identifier used in the login).

The video game application 110 can present image information, such as the visual frames of the video application. In response to an interaction with a video game controller 104, the video game application 110 can display a movement in the video game application that corresponds to the interaction. For example, if the video game controller 104 is interacted with to indicate forward motion, the video game application can cause an image of a character to appear to move forward. The video game application can further present audio corresponding to the video game application. The audio information can include, for example, music presented during game play,

The video game controller 104 is an example of an input device. The video game controller 104 may allow the video game player 108 to interact with one or more GUIs presented by the video game console 102 on the display 106. For example, using one or more directional control inputs (e.g., a joystick and/or a directional pad) the user can navigate to and within various menus, dashboards, and UI elements. The interaction with the video game controller 104 can be converted into electrical signals and transmitted to a cloud server as controller information. Other types of the input device are possible including, a keyboard, a touchscreen, a touchpad, a mouse, an optical system, a microphone, a camera, or other user devices suitable for receiving input of a user. For example, a microphone may allow the video game player 108 to interact with the GUIs using various voice commands. As another example, a camera may allow the video game player 108 to interact with the GUIs using various gesture commands.

Upon an execution of the video game application 110 by the video game console 102, a rendering process of the video game console 102 presents video game content (e.g., illustrated as a car race video game content) on the display 106. Upon user input from the video game controller 104 (e.g., a user push of a particular key or button), the rendering process also presents the menu. Additionally, or alternatively, the menu may be presented as an initial landing page in response to a user powering-on the video game console 102 and/or waking the video game console 102 from a suspended state. Depending on the user input, the menu corresponds to the home UI page, a landing page, or the like. The menu can be presented in a layer over the video game content.

Although FIG. 1 illustrates that the different applications are executed on the video game console 102, the embodiments of the present disclosure are not limited as such. Instead, the applications can be executed on the backend system (e.g., the cloud servers) and/or their execution can be distributed between the video game console 102 and the backend system.

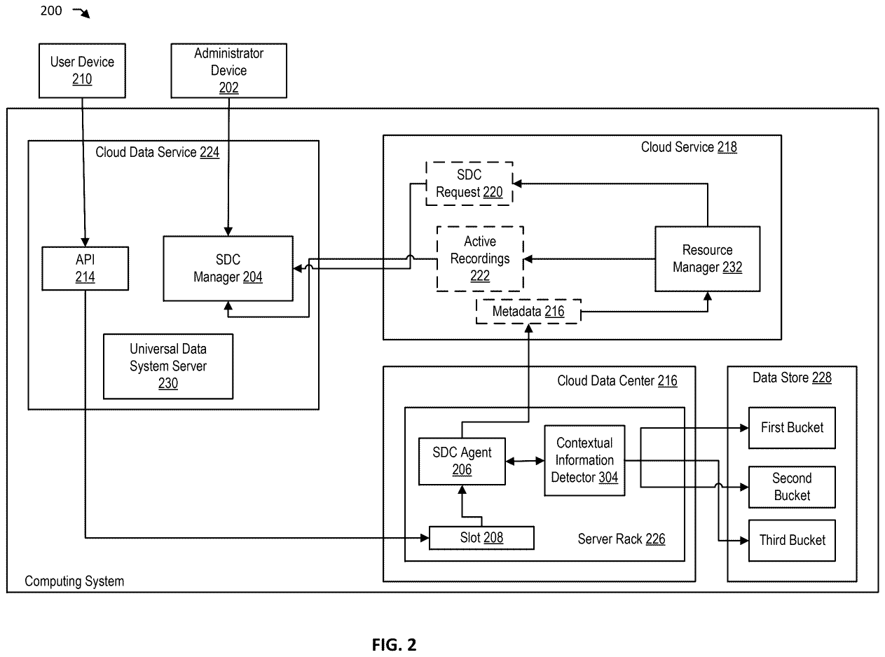

FIGS. 2-6 describe different aspects of a computing system for collecting video game information.

FIG. 2 is an illustration 200 of an example system for game play data collection, according to one or more embodiments. An administrator device 202 can transmit instructions to a software-defined compute (SDC) manager 204, which can be a computing system of a data service 224 that manages resources in a cloud computing environment. The instructions can include collecting video game information for a particular video game application. The instructions can include a video game application identifier and types of information to be collected (e.g., image information, audio information, metadata, and controller information). The image information can include image frame information for images displayed during game play of a video game application. The audio information can include waveform information for audio presented during the game play. The metadata can include game play information, such as level, character specifications, item inventory, settings, missions completed, bosses defeated, or other metadata. The controller information can include inputs to the controller (e.g., button interactions, joystick directions, haptic information or other controller information).

The SDC manager 204 can transmit instructions to an SDC agent 206 to collect information from a slot 208 in the event that the video game application is played. The SDC agent 206 can be an intermediary device that manages resources in a cloud computing environment on behalf of the SDC manager 204. The slot 208 can be a combination of hardware and software that represents a unit of capacity of a server, in a server rack 226, that is allocated for a single player to connect to the server and play a video game application. For example, a twenty-slot server can accommodate twenty players.

At a point in time, a user device (e.g., video game console 102) can transmit a request to initialize a video game application (e.g., a cloud computing video game application) via an application programming interface (API) 212. The request can be received at a data center. The video game application can be executed at the slot 208. The SDC agent can monitor the slot 208, and based on the video game application identifier determine that the requested video game information is for the video game application being executed at the slot 208. The SDC agent 206 can communicate with an application executing on the slot to collect video game information. The video game information can be collected in real time as a player is using the user device 210 to play the video game application. For example, the application can access an output of a graphics processing unit (GPU) that is processing controller information and determining image frame information to be sent back to the user device 210 and displayed for the player. This output can include the image information corresponding to the controller information. Furthermore, so as not to interrupt the player's gaming experience, the output is also transmitted back to the user device 210 that is engaged in the cloud-based video game application session in real time. Additionally, the application can access an output of an audio processing unit (APU) that is processing controller information and determining an audio file to be sent back to the user device 210 and presented during game play. This output can include the audio information corresponding to the controller information. As indicated above, so as to not interrupt the player's experience The output can also be transmitted to the user device engaging the cloud-based session in real time.

The SDC agent 206 can transmit metadata 216 collected from the video game application to a cloud service. The metadata 216 can be high-level metadata that includes, for example, session information, such as a rack name, a datacenter name, a slot number, a collection status, a collection duration, or other session information. The metadata 216 can be reported to a cloud service (e.g., cloud data service 224) that is managed by the SDC manager 204. The metadata 216 can be used for various purposes, such as provisioning computing resources. For example, the metadata 216 can be used by a resource manager 232 that can make an SDC request 220, which can include a request to provision the computing system (e.g., central processing unit (CPU) cores, memory, storage) based on the metadata 216. The resource manager 232 can also provide active recordings information 222 to the SDC manager 204. The SDC manager 204 can provision more or fewer resources based on the SDC request 220 and the active recordings information 222.

In some embodiments, the collection of video game information can be limited by particular parameters. For example, the SDC manager 204 can indicate a time interval (e.g., one thousand hours) for collection. The SDC agent 206 can start a timer each time that video game information for a particular video game application (e.g., Horizon Zero Dawn) is collected. The SDC agent can monitor more than one slot and the timer can be continuous timer for the total time interval for each instance of the video game application at each slot. The SDC manager 204 can also transmit instructions to ensure diversity in the data collected. For example, the SDC manager 204 can instruct each SDC agent 206 to collect video game information related to specific video game application contextual information (e.g., settings, weapon loadouts, mini-bosses, bosses, known glitches, or other video game application contextual information). Therefore, even if the SDC manager 204 has indicated a time interval, if the SDC agent 206 determines that information including one or more contextual information has not been collected, the SDC agent 206 can continue to cause information to be collected past the expiration of the timer.

The SDC agent 206 can cause the transmission of the video game information (e.g., image information, audio information, and controller information) to a data store 228. For example, the data store 228 can store frame by frame gameplay metadata, such as frame numbers, timestamps or events (e.g., on-screen keyboard popups, universal data system (UDS) notifications, such as boss fight start, boss fight end and the like). In some instances, the video game information is to be used for desired purposes (e.g., debugging or other desired purpose). The SDC agent 206 can cause the video game information to be formatted for the desired purpose. For example, the SDC agent can cause metadata to be added to indicate a video game identifier, a video game contextual information, potential bug, or other formatting information. In another example, the SDC agent 206 can cause the video game information to be formatting for a machine learning model.

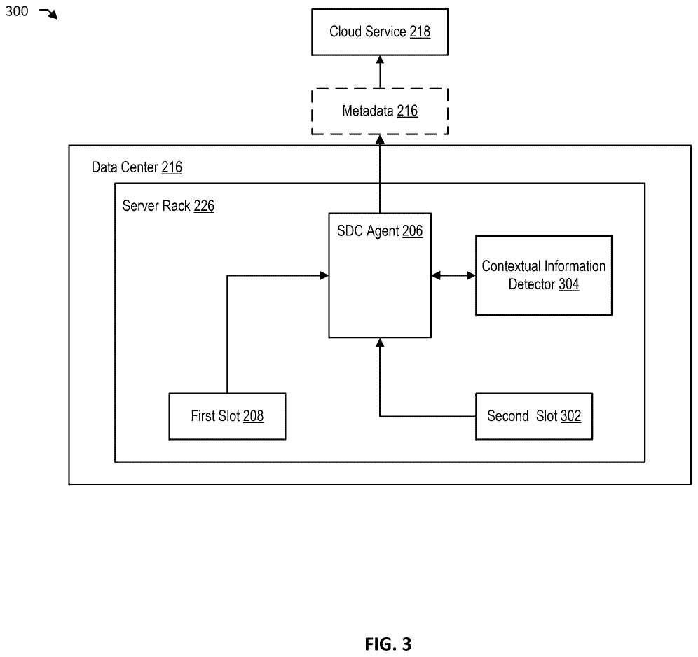

In some embodiments, the SDC agent 206 can be in communication with a contextual information detector 304. The contextual information detector 304 can be configured to analyze information (e.g., audio information, video information, and controller information) received from a video game application and determine whether desired contextual information has been collected. The contextual information detector 304 is described with more particularity with respect to FIG. 3.

In some embodiments, the computing system can include a universal data system (UDS) server 230. The user device 210 can provide contextual information regarding at least one video game application to the UDS server 230 via a UDS data model describing the logical structure of UDS data used by a UDS software developer kit (SDK) operating on the user device 210. The UDS data model can enable the video game application executing on the slot 208 to realize remote networked services, such as the help service, debugging service, and other services that require game data, without requiring a game to be patched separately to support a service. The UDS data model can assign contextual information to a portion of information in a unified way across video game applications. The contextual information from the UDS SDK can be provided to the UDS server 230 via the user device 210.

The UDS server 230 can receive and store contextual information from the user device 210 from one or more video game applications. The information may be uniformly processed and then received by the SDC manager 204 and any remote networked services. In some embodiments, the contextual information can be a trigger for initiating collection of video game information for a cloud-based session. For example, the administrator device 202 can provide instructions indicating that particular contextual information can trigger the collection of video game information.

FIG. 3 is an illustration 300 of an example system for game play data collection, according to one or more embodiments. As illustrated, an SDC agent 206 can collect information from more than one slot. For example, the SDC agent 206 can collect information from a first slot 208 and a second slot 302. Each slot can collect information from the same video game application (e.g., God of War), or the first slot 208 can collect video game information from one video game application (e.g., Horizon Zero Dawn) and the second slot 302 can collect video game information for another video game application (e.g., God of War). The SDC agent 206 can further be in communication with a contextual information detector 304 that can process controller information, image information (e.g., image information outputted from a GPU) and audio information (e.g., audio information outputted by an APU). As indicated above, to improve the diversity of the video game information collected, the SDC manager 204 can transmit one or more contextual information to be collected. The contextual information detector 304 can determine which contextual information (e.g., settings, weapon loadouts, mini-bosses, bosses, known glitches, or other video game application contextual information) is to be collected for which video game application. The contextual information detector 304 can further use various processing techniques (image processing on rendered image frames, audio analysis on an audio file, instruction analysis for outputted instructions. The SDC agent 206 can use the analysis of the contextual information detector 304 to determine whether the desired contextual information indicated by the SDC manager 204 has been collected. Based on this determination, the SDC agent 206 can continue to collect information if all of the contextual information has not been collected, or discontinue collection if all of the contextual information has been detected and no other restrictions (e.g., time interval) suggest information collection should continue. For example, if the SDC agent 206 determines that a time interval for video game application collection has not expired, the SDC agent 206 can continue to collect information. If, however, the time interval has expired, and all of the desired contextual information have collected, the SDC agent 206 can discontinue collecting video game information.

As indicated above, the SDC agent 206 can continue to transmit metadata 216 to the cloud service 218. As illustrated in FIG. 3, the metadata 216 can include session data that is provided by the SDC agent 206.

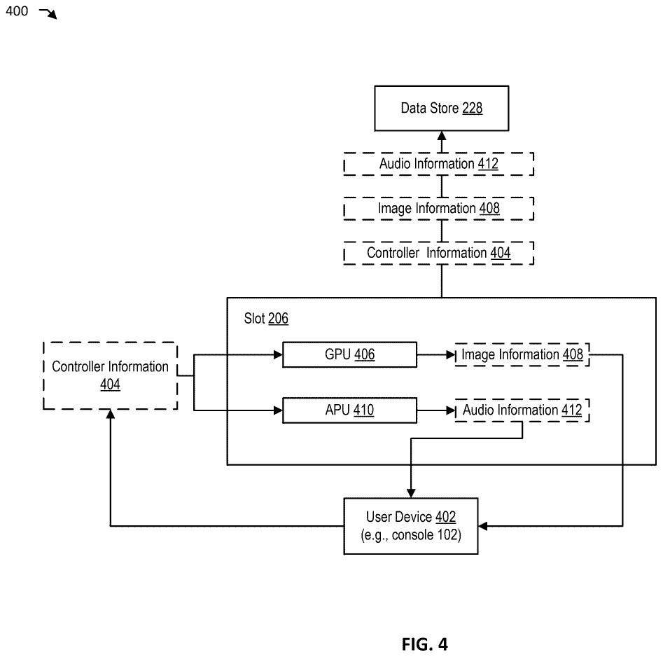

FIG. 4 is an illustration 400 of an example system for game play data collection, according to one or more embodiments. A user device 402 (e.g., a console) can transmit controller information 404 to a slot 208. For example, a video game player 108 can use a controller 104 that is either has a wired or wireless connection with the user device 402. The video game player 108 interact with one or more inputs (e.g., buttons, joysticks, or other inputs). These interactions can be converted to controller information (e.g., electrical signals corresponding to the interaction) that is transmitted by the user device 402 to the slot 208. The slot 208 can include a GPU 406 that can convert the controller information into image information 408. For example, if the controller information indicates that a player has swung an axe, the GPU 406 can generate image information 408 that includes image frames of a character swinging an axe. The slot 208 can include an APU 410 that can convert the controller information 404 into audio information 412. For example, if the controller information 404 indicates that the character has swung an axe, the audio information 412 can include an audio file representing the sound of an axe being swung.

As illustrated, both the GPU 406 and the APU 410 receive the controller information 404. Furthermore, it is illustrated that image information 408 and the audio information 412 can be synchronized and correspond to the same controller information 404. For example, the image information 408 and the audio information 412 can be synchronized with the controller information 404. Using the example from above, the images of an axe swinging are to be synchronized with the controller input to cause the character to swing the axe and the sound of the axe swinging.

The image information 408 and the audio information 412 can be transmitted back to the user device 402 to allow the video game player 108 to continue enjoying their game play. In some embodiments, the controller information 404, the image information 408, and the audio information 412 can further be transmitted to a contextual information detector 304, that can be configured to determine if video game information for one or more desired contextual information items has been collected. The SDC agent 206 can use this information to determine whether to continue collecting video game information.

The SDC agent 206 can cause the synchronized controller information 404, image information 408, and audio information 412 to be transmitted a data store. In some embodiments, the synchronized controller information 404, image information 408, and audio information 412 can be transmitted to the data store 228 continuously as it is collected. In other embodiments, the SDC agent 206 can cause the synchronized controller information 404, image information 408, and audio information 412 to be transmitted after a condition is met (e.g., expiration of a timer, collection of each desired contextual information, or other condition).

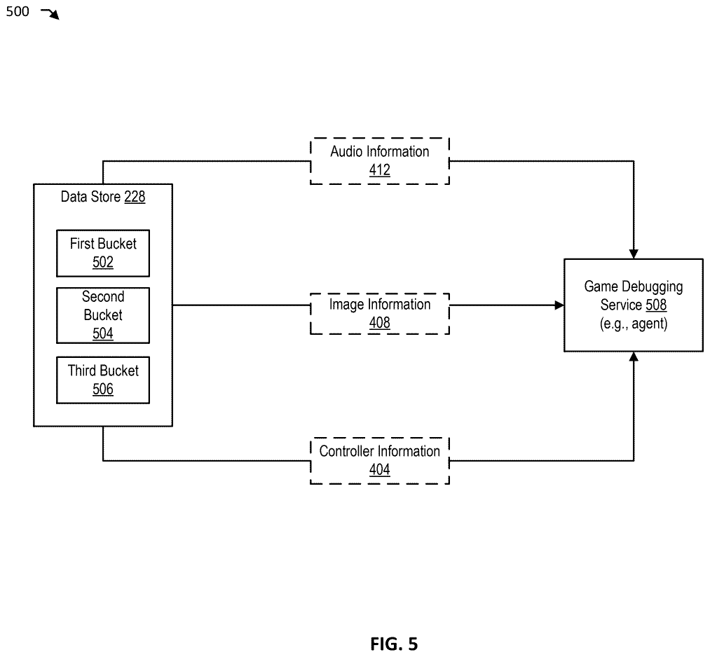

FIG. 5 is an illustration 500 of an example system for game play data collection, according to one or more embodiments. The video game information can be stored in various buckets, such as a first bucket 502, a second bucket 504, or a third bucket 506, in the data store 228. The various buckets can have different properties. For example, each bucket can have different access control mechanisms for different levels of security. In another example, data in each bucket can be formatted differently for different services. For example, one bucket can be formatted for debugging, another bucket can be formatted to be used as training data for a machine learning model. and another bucket can be formatted for general purpose use.

As illustrated the controller information 404, the image information 408, and the audio information 412 can be transmitted for a desired purpose, such as a game debugging service 508. The debugging service can use the synchronized video game information to identify bugs in the video game application. In some instances, the game debugging service 508 make include a machine learning model agent (e.g., an artificial neural network (ANN), a convolutional neural network (CNN), or other machine learning model agent). Therefore, in some embodiments, the SDC agent 206 can cause the video game information to be formatted for the type of machine learning model agent.

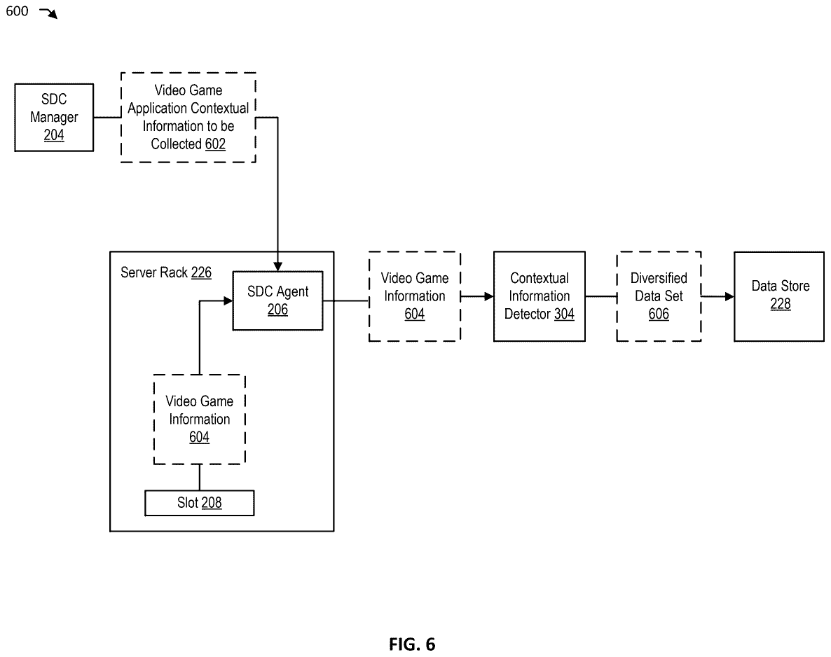

FIG. 6 is an illustration 600 of an example system for game play data collection, according to one or more embodiments. As indicated above, the computing system can be configured to collect a diverse set of data. The SDC manager 204 can transmit a message that includes video game application contextual information to be collected 602 to the SDC agent 206. In some instances, the SDC manager 204 can communicate with a cloud-based game engine that can communicate with the SDC agent 206. The SDC agent 206 can receive video game information (e.g., controller information 404, image information 408, audio information 412) from the slot 208. The contextual information detector 304 can process video game information 604 (e.g., the controller information 404 provided to a slot 208 and the image information 408 and audio information 412 that is output in response to receiving the controller information 404). The contextual information detector 304 can use various techniques (e.g., image processing, audio processing, or other techniques) to analyze the information. For example, the contextual information detector 304 can be provided a representation or template of a desired contextual information (e.g., a setting, a boss or other contextual information). The contextual information detector 304 can then compare the representation and/or the template to the images outputted by the GPU to determine if there is a match. The contextual information detector 304 can also be provided with an audio file of representing a desired audio. The contextual information detector 304 can then compare the audio file with audio outputted by the APU to determine if there is a match. The contextual information detector 304 can also be provided with electrical signal representations of controller inputs. The contextual information detector 304 can then compare the electrical signal representations with electrical signals from the controller to determine if there is a match. In some embodiments, the representation, template, audio representations and/or electrical signal representations can be provided to the contextual information detector 304 from the SDC manager 204 via the SDC agent 206. For example, the SDC manager 204 can transmit this information in the same message as the video game application contextual information to be collected 602, or in a different message.

The contextual information detector 304 can generate information that indicates which contextual information has been collected, and which contextual information have not been collected. The SDC agent 206 can receive the information and compare it with the video game application contextual information to be collected 602. Based on the comparison, the SDC agent 206 can cause video game information to continue to be collected. Or the SDC agent 206 can discontinue collecting video game information. For example, if all of the desired contextual information has been collected, the SDC agent 206 can discontinue collecting video game information. If, however, all of the desired video game application contextual information has not been collected, the SDC agent can continue to collect the video game information.

The desired contextual information can ensure that a diversified data set 606 has been generated. For example, without the desired contextual information, it is possible that a timer for collecting video game information expires and certain aspects of a video game application are never collected. The desired contextual information may be associated with coding errors, stages that are too difficult to traverse or other issues that impact the game play experience. For example, there may be a rarely explored dungeon that is glitched due to a coding error that is not collected. There may also be an anomaly, such as a character can walk through a wall, where the video game physics engine should prevent this occurrence. Without this information, the error may not be identified and corrected. Therefore, the video game information that is stored in the data store 228 should include the necessary information to identify issues that affect the game play experience.

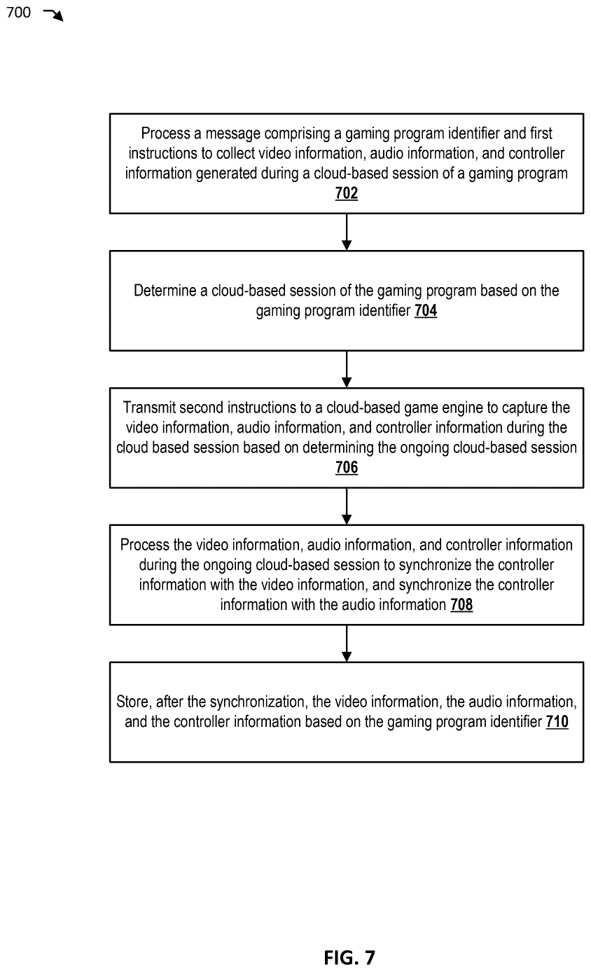

FIG. 7 is an example process 700 for game play data collection, according to one or more embodiments. At 702, the process 700 can include a computing system processing a message that includes a video game application identifier and first instructions to collect image information, audio information, and controller information generated during a cloud-based session of a video game application.

In some embodiments, an SDC manager can receive a video game application identifier and an indication to collect the image information, audio information, and controller information. The SDC manager can generate the message comprising the video game application identifier and first instructions. The SDC manager can transmit the instructions to the SDC agent.

At 704, the process 700 can include the computing system determining that the cloud-based session (e.g., an ongoing cloud-based session) of the video game application is occurring based on the video game application identifier.

At 706, the process 700 can include the computing system collecting the image information, the audio information, and the controller information during the cloud-based session based on determining the cloud-based session.

For example, the computing system can process the controller information from the ongoing cloud-based gaming session. The computing system can then access a first output of a graphics processing unit (GPU). The first output can include the image information corresponding to the controller information. The first output can further be transmitted to a user device that is engaging in the cloud-based session. The computing system can access a second output of an audio processing unit (APU). The second output can include the audio information corresponding to the controller information. The second output is further transmitted to the user device that is engaging in the cloud-based session.

In some embodiments, the computing system can determine a second cloud-based session of the video game application. The computing system can further receive the image information, audio information, and controller information from both the cloud-based session and the second cloud-based session.

At 708, the process 700 can include the computing system synchronizing the controller information with the image information and the controller information with the audio information to generate synchronized video game information.

In some embodiments, the computing system can determine a reference time point (e.g., a point in time of a controller input) The computing system can further synchronize the image information, audio information, and controller information with respect to the time point.

In some embodiments, the computing system (e.g., SDC agent) can generate metadata comprising at least one of number of image frames collected, time interval of collection, or number of cloud-based sessions. This information can be transmitted to the SDC manager. The SDC manager can determine whether to continue collecting the image information, audio information, and controller information based on the metadata.

In some embodiments, the computing system can receive contextual information collected at a user device. For example, the information can be transmitted to a UDS server from a user device and the UDS server can transmit the information to the SDC manager. The SDC manager can then determine second contextual information to collect based on the contextual information. For example, the SDC manager may have been provided, from an administrator device, a first contextual information (e.g., a setting, a boss or other contextual information) to identity in the video game information. Based on the contextual information, the SDC agent may identify a second contextual information (e.g., a weapons loadout, a character type or other second contextual information) based on the contextual information).

In some embodiments, the message further indicates a video game application anomaly. In these embodiments, the computing system can process, after the synchronization, at least one of the image information, the audio information, or the controller information to identify the game program anomaly. In some embodiments, the computing system can generate metadata associated with collecting the image information, the audio information, and the controller information. The computing system can further update a parameter for collecting the image information, the audio information, and the controller information based on the metadata.

In some embodiments, the message indicates a time interval. In these embodiments, the computing system can collect the image information, the audio information, and the controller information for the time interval. The computing system can then determine whether one of the image information, the audio information, or the controller information comprises the video game application contextual information. The computing system can then collect the image information, the audio information, and the controller information after the expiration of the time interval based on determining whether one of the image information, the audio information, or the controller information comprising the video game application contextual information.

At 710, the process 700 can include the computing system storing the synchronized video game information based on the video game application identifier. In some embodiments, the computing system can format the stored image information, audio information, and controller information for debugging video game application code.

In some embodiments, the computing system can generate metadata to identify the second contextual information from the image information, audio information, and controller information. The computing system can further augment the image information, audio information, and controller information to include the metadata.

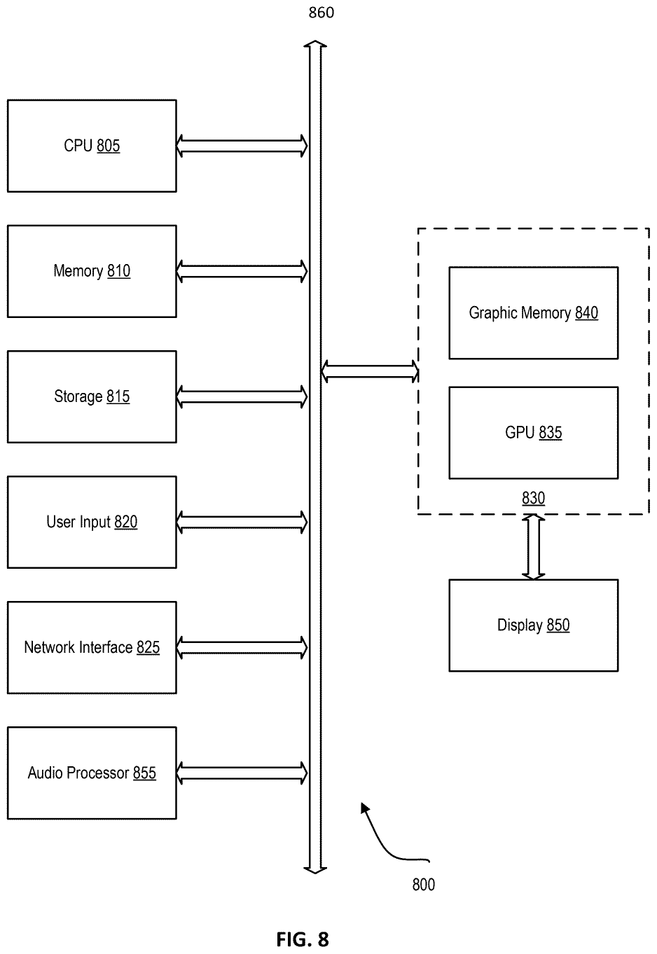

FIG. 8 illustrates an example of a hardware system suitable for implementing a computer system, according to embodiments of the present disclosure. The computer system 800 represents, for example, a video game system, a backend set of servers, or other types of a computer system. The computer system 800 includes a central processing unit (CPU) 805 for running software applications and optionally an operating system. The CPU 805 may be made up of one or more homogeneous or heterogeneous processing cores. Memory 810 stores applications and data for use by the CPU 805. Storage 815 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 820 communicate user inputs from one or more users to the computer system 800, examples of which may include keyboards, mice, joysticks, touch pads, touch screens, still or video cameras, and/or microphones. Network interface 825 allows the computer system 800 to communicate with other computer systems via an electronic communications network, and may include wired or wireless communication over local area networks and wide area networks such as the Internet. An audio processor 855 is adapted to generate analog or digital audio output from instructions and/or data provided by the CPU 805, memory 810, and/or storage 815. The components of computer system 800, including the CPU 805, memory 810, data storage 815, user input devices 820, network interface 825, and audio processor 855 are connected via one or more data buses 860.

A graphics subsystem 830 is further connected with the data bus 860 and the components of the computer system 800. The graphics subsystem 830 includes a graphics processing unit (GPU) 835 and graphics memory 840. The graphics memory 840 includes a display memory (e.g., a frame buffer) used for storing pixel data for each pixel of an output image. The graphics memory 840 can be integrated in the same device as the GPU 835, connected as a separate device with the GPU 835, and/or implemented within the memory 810. Pixel data can be provided to the graphics memory 840 directly from the CPU 805. Alternatively, the CPU 805 provides the GPU 835 with data and/or instructions defining the desired output images, from which the GPU 835 generates the pixel data of one or more output images. The data and/or instructions defining the desired output images can be stored in the memory 810 and/or graphics memory 840. In an embodiment, the GPU 835 includes 3D rendering capabilities for generating pixel data for output images from instructions and data defining the geometry, lighting, shading, texturing, motion, and/or camera parameters for a scene. The GPU 835 can further include one or more programmable execution units capable of executing shader programs.

The graphics subsystem 830 periodically outputs pixel data for an image from the graphics memory 840 to be displayed on the display device 850. The display device 850 can be any device capable of displaying visual information in response to a signal from the computer system 800, including CRT, LCD, plasma, and OLED displays. The computer system 800 can provide the display device 850 with an analog or digital signal.

In accordance with various embodiments, the CPU 805 is one or more general-purpose microprocessors having one or more processing cores. Further embodiments can be implemented using one or more CPUs 805 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 76%, 135%, 90%, 100%, 105%, 109%, 109.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method comprising:
processing a message comprising a video game application identifier and first instructions to collect image information, audio information, and controller information generated during a cloud-based session of a video game application;
determining the cloud-based session of the video game application based on the video game application identifier;
collecting the image information, the audio information, and the controller information during the cloud-based session based on determining the cloud-based session;
synchronizing the controller information with the image information and the controller information with the audio information to generate synchronized video game information; and
storing the synchronized video game information based on the video game application identifier.

2. The method of claim 1, whether in the method further comprises:
processing the controller information from the cloud-based gaming session;
accessing a first output of a graphics processing unit (GPU), wherein the first output comprises the image information corresponding to the controller information, and wherein the first output is further transmitted to a user device engaging the cloud-based session; and
accessing a second output of an audio processing unit (APU), wherein the second output comprises the audio information corresponding to the controller information, and wherein the second output is further transmitted to the user device engaging the cloud-based session.

3. The method of claim 1, wherein the message further indicates a video game application anomaly, wherein the method further comprises:
processing, after the synchronization, at least one of the image information, the audio information, or the controller information to identify the game program anomaly.

4. The method of claim 3, wherein method further comprises:
updating the at least one of the image information, the audio information, or the controller information with metadata indicting the video game application anomaly.

5. The method of claim 1, wherein the message further indicates a time interval for collecting the image information, the audio information, and the controller information, wherein the message further indicates a game program contextual information, and wherein the method further comprises:
collecting the image information, the audio information, and the controller information for the time interval;
determining whether one of the image information, the audio information, or the controller information corresponds to the game program contextual information; and
collecting the image information, the audio information, and the controller information after expiration of the time interval based on determining whether one of the image information, the audio information, or the controller information corresponds to the game program contextual information.

6. The method of claim 1, wherein the method further comprises:
formatting the stored image information, audio information, and controller information for debugging video game application code.

7. The method of claim 1, wherein the method further comprises:
generating metadata associated with collecting the image information, the audio information, and the controller information; and
updating a parameter for collecting the image information, the audio information, and the controller information based on the parameter.

8. The method of claim 1, wherein the synchronization occurs during an ongoing cloud-based session.

9. A computing system comprising:
one or more processors; and
one or more computer-readable media comprising a sequence of instructions that, when executed, cause the one or more processors to:
process a message comprising a video game application identifier and first instructions to collect image information, audio information, and controller information generated during a cloud-based session of a video game application;
determine a cloud-based session of the video game application based on the video game application identifier;
transmit second instructions to a cloud-based game engine to collect the image information, audio information, and controller information during the cloud-based session based on determining the cloud-based session;
process the image information, audio information, and controller information during the cloud-based session to synchronize the controller information with the image information, and synchronize the controller information with the audio information; and
store, after the synchronization, the image information, the audio information, and the controller information based on the video game application identifier.

10. The computing system of claim 8, wherein the sequence of instructions that, when executed, further cause the one or more processors to:
determine a second cloud-based session of the video game application; and
receive the image information, audio information, and controller information from the cloud-based session and the second cloud-based session.

11. The computing system of claim 8, wherein the computing system comprising a manager and an agent, and wherein the sequence of instructions that, when executed, further cause the one or more processors to:
receive, at the manager, a video game application identifier and an indication to collect the image information, audio information, and controller information;
generate, by the manager, the message comprising the video game application identifier and first instructions; and
transmit the message from the manager to the agent.

12. The computing system of claim 10, wherein the sequence of instructions that, when executed, further cause the one or more processors to:
generate metadata comprising at least one of number of image frames collected, time interval of collection, or number of cloud-based sessions; and
determining whether to continue collecting the image information, audio information, and controller information based on the metadata.

13. The computing system of claim 8, wherein the sequence of instructions that, when executed, further cause the one or more processors to:
receiving contextual information collected at a user device; and
determining second contextual information based on the contextual information, wherein the message further comprises instructions to capture the second contextual information.

14. The computing system of claim 13, wherein the sequence of instructions that, when executed, further cause the one or more processors to:
generating metadata to identify the second contextual information from the image information, audio information, and controller information; and
augmenting the image information, audio information, and controller information to comprise the metadata.

15. The computing system of claim 8, wherein the sequence of instructions that, when executed, further cause the one or more processors to:
determining a reference time point, wherein the image information, audio information, and controller information are synchronized with respect to the time point.

16. One or more non-transitory, computer-readable media comprising a sequence of instructions that, when executed, cause one more processors to:
process a message comprising a video game application identifier and first instructions to collect image information, audio information, and controller information generated during a cloud-based session of a video game application;
determine a cloud-based session of the video game application based on the video game application identifier;
transmit second instructions to a cloud-based game engine to collect the image information, audio information, and controller information during the cloud-based session based on determining the cloud-based session;
process the image information, audio information, and controller information during the cloud-based session to synchronize the controller information with the image information, and synchronize the controller information with the audio information; and
store, after the synchronization, the image information, the audio information, and the controller information based on the video game application identifier.

17. The one or more non-transitory, computer-readable media of claim 15, wherein the sequence of instructions that, when executed, further cause the one or more processors to:
process the controller information from the cloud-based gaming session;
access a first output of a graphics processing unit (GPU), wherein the first output comprises the image information corresponding to the controller information; and
access a second output of an audio processing unit (APU), wherein the second output comprises the audio information corresponding to the controller information.

18. The one or more non-transitory, computer-readable media of claim 15, wherein the message further indicates a video game application anomaly, and wherein the sequence of instructions that, when executed, further cause the one or more processors to:
process, after the synchronization, at least one of the image information, the audio information, and the controller information to identify the video game application anomaly.

19. The one or more non-transitory, computer-readable media of claim 17, wherein the sequence of instructions that, when executed, further cause the one or more processors to:
update the at least one of the image information, the audio information, and the controller information with metadata indicting the video game application anomaly.

20. The one or more non-transitory, computer-readable media of claim 15, wherein the message further indicates a time interval for collecting the image information, the audio information, and the controller information, wherein the message further indicates a video game application contextual information, and wherein the sequence of instructions that, when executed, further cause the one or more processors to:
collect the image information, the audio information, and the controller information for the time interval;
determine whether one of the image information, the audio information, or the controller information comprises the video game application contextual information; and
collect the image information, the audio information, and the controller information after expiration of the time interval based on determining whether one of the image information, the audio information, or the controller information comprises the video game application contextual information.
